(19) United States
(12) Patent Application Publication
(10) Pub. No.: US 2026/0202578 A1
(43) Pub. Date: Jul. 16, 2026

(54) TECHNOLOGIES FOR PREDICTING WIND TURBULENCE INTENSITIES USING ENHANCED MACHINE LEARNING TECHNIQUES

(71) Applicant: UL LLC, Northbrook, IL (US)

(72) Inventors: Grasiele Santos, Itajubá (BR); Philippe Beaucage, Brossard (CA)

(21) Appl. No.: 19/448,434

(22) Filed: Jan. 14, 2026

Related U.S. Application Data
(60) Provisional application No. 63/745,086, filed on Jan. 14, 2025.

(51) Int. Cl. G01W 1/10; G06N 20/00

(52) U.S. Cl. CPC G01W 1/10; G06N 20/00

(57) ABSTRACT

Systems and methods for predicting wind turbulence intensity (TI) values of geographic locations using enhance machine learning techniques are disclosed. According to certain aspects, an electronic device may train a machine learning model using a set of Weather Research and Forecasting (WRF) time series data and observed wind speed data. The electronic device may use the trained machine learning model to analyze a set of input WRF time series data associated with a set of geographic locations, and the machine learning model may output predicted TI values corresponding to the set of geographic locations. The electronic device may generate a digital report indicating the predicted TI values and other relevant information.

### CROSS-REFERENCE TO RELATED APPLICATIONS

This application claims priority to U.S. Patent Application No. 63/745,086, filed January 14, 2025, the disclosure of which is hereby incorporated by reference in its entirety.

### FIELD

The present disclosure is directed to improvements in predicting wind turbulence intensities. More particularly, the present disclosure is directed to platforms and technologies for utilizing enhanced machine learning techniques to more accurately predict wind turbulence intensities associated with geographic locations.

### BACKGROUND

The development of wind farms has become an essential component in meeting the growing demand for renewable energy. A critical factor in the successful design and operation of wind farms is the accurate assessment of atmospheric turbulence intensity at prospective wind farm sites. Turbulence intensity (TI) is a key metric for understanding the variability in wind conditions, which has a direct impact on the structural integrity and longevity of wind turbines. Large fluctuations in wind speed and direction, particularly on time scales of seconds to minutes, can cause significant fatigue on turbine components, leading to increased maintenance costs and potential failure of wind turbines over time.

In order to mitigate these risks, wind farm developers and investors must have reliable data regarding the TI profile at a given site during the planning stages. The ability to predict and model TI allows for better-informed decisions on turbine placement, structure design, and overall wind farm layout. However, current methods used in the energy industry to estimate TI present significant limitations.

For example, the normal turbulence model (NTM) outlined in the IEC 61400-1 standard is widely used but is overly simplistic and does not capture the complexities of atmospheric turbulence with sufficient accuracy. Additionally, more advanced techniques, such as Large Eddy Simulations (LES), provide detailed insights but are computationally expensive and impractical for large-scale applications. Even widely-used models like the Weather Research and Forecasting (WRF) model, while more sophisticated, do not deliver the expected performance levels in estimating turbulence intensity with the precision required for optimal wind farm planning.

Therefore, there is an opportunity for improved systems and methods that address these shortcomings. An improved solution would enhance the understanding of TI at existing or prospective wind farm sites, reduce the risk of turbine fatigue and failure, and support more effective planning and investment decisions in the wind energy industry.

### SUMMARY

In an embodiment, a computer-implemented method of predicting wind turbulence intensities at prospective wind farm sites is provided. The computer-implemented method may include: accessing, by at least one computer processor, (i) a set of time series data representing a plurality of simulated turbulence intensity (TI) values across a plurality of geographic locations, and (ii) a set of observed data comprising a plurality of wind speed values collected over a set of time intervals, at a plurality of different sensor heights, and at a plurality of observed geographic locations; calculating, by the at least one computer processor from the set of observed data, a plurality of observed TI values; collocating, by the at least one computer processor, the set of time series data with the set of observed data; training, by the at least one computer processor, a machine learning model using the collocated set of time series data labeled with at least a portion of the plurality of observed TI values; accessing, by the at least one computer processor, a set of input time series data associated with a set of input geographic locations; analyzing, by the at least one computer processor using the trained machine learning model, the set of input time series data; and based on analyzing the set of input time series data, outputting, by the trained machine learning model, a set of predicted TI values corresponding to the set of input geographic locations.

In another embodiment, a system for predicting wind turbulence intensities at prospective wind farm sites is provided. The system may include: a memory storing a set of computer-readable instructions and a machine learning model; and at least one computer processor interfaced with the memory. The at least one computer processor may be configured to execute the set of computer-readable instructions to cause the at least one computer processor to: access (i) a set of time series data representing a plurality of simulated turbulence intensity (TI) values across a plurality of geographic locations, and (ii) a set of observed data comprising a plurality of wind speed values collected over a set of time intervals, at a plurality of different sensor heights, and at a plurality of observed geographic locations, calculate, from the set of observed data, a plurality of observed TI values, collocate the set of time series data with the set of observed data, train a machine learning model using the collocated set of time series data labeled with at least a portion of the plurality of observed TI values, access a set of input time series data associated with a set of input geographic locations, analyze, using the trained machine learning model, the set of input time series data, and based on analyzing the set of input time series data, output, by the trained machine learning model, a set of predicted TI values corresponding to the set of input geographic locations.

Further, in an embodiment, a non-transitory computer-readable storage medium configured to store instructions executable by one or more processors is provided. The instructions may include: instructions for accessing (i) a set of time series data representing a plurality of simulated turbulence intensity (TI) values across a plurality of geographic locations, and (ii) a set of observed data comprising a plurality of wind speed values collected over a set of time intervals, at a plurality of different sensor heights, and at a plurality of observed geographic locations; instructions for calculating, from the set of observed data, a plurality of observed TI values; instructions for collocating the set of time series data with the set of observed data; instructions for training a machine learning model using the collocated set of time series data labeled with at least a portion of the plurality of observed TI values; instructions for accessing a set of input time series data associated with a set of input geographic locations; instructions for analyzing, using the trained machine learning model, the set of input time series data; and instructions for, based on analyzing the set of input time series data, outputting, by the trained machine learning model, a set of predicted TI values corresponding to the set of input geographic locations.

### BRIEF DESCRIPTION OF THE FIGURES

FIG. 1 depicts an overview of components and entities associated with the systems and methods, in accordance with some embodiments.

FIG. 2 depicts an example signal diagram detailing employing enhanced machine learning techniques to predict TI values, in accordance with some embodiments.

FIGS. 3A-3C depict example visuals related to an analysis of the enhanced machine learning techniques, in accordance with some embodiments.

FIG. 4 illustrates an example flow diagram of predicting turbulence intensities associated with wind turbines, in accordance with some embodiments.

FIG. 5 is an example hardware diagram of a wind turbine and a server configured to perform various functionalities, in accordance with some embodiments.

### DETAILED DESCRIPTION

The present embodiments may relate to, inter alia, using enhanced machine learning techniques to more accurately predict TI values for geographic locations. According to certain aspects, a computing device may train a machine learning model using a set of WRF time series data that is collocated with a set of observed data that may include a plurality of observed wind speed values. The trained machine learning model may analyze a set of input WRF time series data associated with a set of input geographic locations and output a set of predicted TI values corresponding to the set of input geographic locations.

Generally, TI values represent the variability of wind speed over a given period and are typically expressed as a percentage that provides insight into how turbulent or stable the wind is at a specific location. Accurate TI prediction is crucial, especially at a prospective wind farm site, because it impacts the performance, efficiency, and lifespan of wind turbines. High TI values lead to greater variability in wind speeds, which increases fatigue loads on components like blades, the rotor, and the tower. Predicting TI accurately allows developers to select turbine models that can withstand these loads, reducing the risk of structural failures. Furthermore, turbines perform more efficiently in stable wind conditions, while high TI can cause fluctuations in power output, making accurate TI prediction essential for estimating potential energy yield and designing optimal turbine layouts. It also plays a critical role in reducing maintenance and operational costs, as consistently high TI levels lead to increased wear and tear, more frequent repairs, and greater downtime. By enabling better planning for maintenance needs, accurate TI prediction minimizes unexpected costs and optimizes operations. For investors, accurately assessing TI reduces uncertainty around energy output and maintenance expenses, offering a clearer picture of financial returns and making the site more attractive for investment. Ultimately, accurately predicting TI ensures the feasibility, safety, and sustainability of wind energy projects.

There are several limitations in how TI values for specific locations are conventionally calculated. In particular, conventional methods for calculating TI values from WRF time series data have several limitations that affect the accuracy and reliability of TI estimates. These methods typically involve straightforward calculations based on mean wind speed and standard deviation over specified time intervals, using basic interpolation to match WRF grid data with specific locations. This approach, however, often fails to account for the complex nature of atmospheric turbulence, as it does not incorporate other critical meteorological factors like atmospheric stability, vertical wind shear, or surface roughness, all of which significantly influence TI. Additionally, the accuracy of these methods is heavily dependent on the spatial and temporal resolution of WRF data. Coarser resolutions or misaligned interpolations can introduce errors, leading to less representative TI values. Furthermore, conventional calculations tend to treat wind speed fluctuations uniformly, missing short-term bursts of turbulence and localized variations that are critical for accurate assessments. This uniform treatment can result in underfitting or overfitting of TI estimates, particularly in complex or varied terrains. The lack of adaptability in these methods also means that TI calculations are often static, unable to adjust dynamically to changing atmospheric conditions or incorporate real-time observations, which limits their effectiveness for high-stakes applications like wind energy planning, aviation safety, and environmental modeling.

The embodiments as described herein represent an improvement in a technology, namely technologies for modeling wind variability. In particular, the embodiments overcome the described challenges by, inter alia, using observed data in combination with WRF time series data to improve the accuracy of TI value predictions. The embodiments calculate observed TI values from the observed data and collocate the WRF time series data with the observed data. Further, the embodiments train and employ a machine learning model that outputs predicted TI values that are more accurate than TI values that are conventionally calculated using WRF time series data. In particular, the embodiments may train the machine learning model using the collocated set of time series data that is labeled with a portion of the observed TI values. The trained machine learning model may analyze a set of input time series data associated with a set of input geographic locations, and output a set of predicted TI values corresponding to the set of input geographic locations.

The described embodiments thus offers numerous benefits across various applications. By integrating machine learning techniques, including the described functionalities for creating a labeled training set and training the machine learning model, the described embodiments provide TI estimates that are far more representative of real-world turbulence patterns. The enhanced accuracy reduces uncertainties in critical decision-making processes, such as wind energy planning, where precise TI measurements are essential for turbine placement, structural design, and maintenance scheduling. The adaptability of the embodiments to local terrain features and varying wind characteristics ensures that the techniques are well-suited for complex geographies, making them a valuable tool for environmental modeling and research. Ultimately, a system capable of delivering more precise and timely TI values leads to more informed and confident decision-making, optimizing performance, reducing operational risks, and enabling more efficient resource allocation across industries.

Additionally, the described embodiments are implemented and operated at a significantly lower computational cost than conventional technologies. By utilizing the enhanced machine learning techniques, the embodiments reduce the amount of computational power and time needed to generate reliable TI estimates. The cost savings from reduced computational demands make it more accessible and feasible for broader use, especially in early-stage planning or for smaller-scale projects where budget constraints are common. Additionally, the faster processing speeds allow for real-time analysis, enabling quicker adjustments to turbine placement, layout, and design, which enhances decision-making agility. This efficiency not only speeds up the assessment phase but also enables more frequent updates of TI predictions, which can improve operational strategies and maintenance planning. Overall, a system that balances accuracy with computational efficiency provides a practical, scalable, and cost-effective solution for both developers and operators, maximizing energy yield and reducing risks while minimizing expenses.

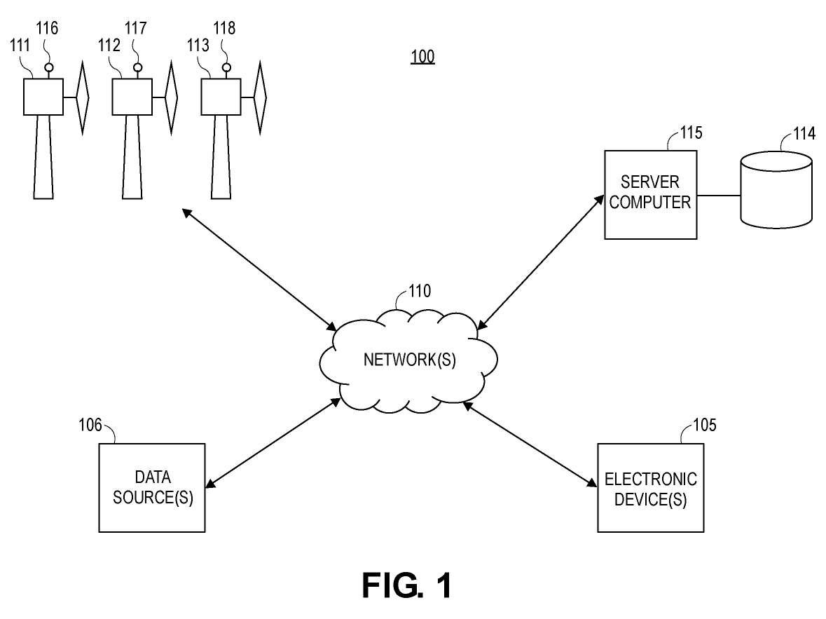

FIG. 1 illustrates an overview of a system 100 of components configured to facilitate the systems and methods. It should be appreciated that the system 100 is merely an example and that alternative or additional components are envisioned.

As illustrated in FIG. 1, the system 100 may include a set of wind turbines 111, 112, 113, each of which is a device that converts the kinetic energy of wind into electrical energy through the rotation of blades. Each of the set of wind turbines 111, 112, 113, may include a set of components (not labeled in FIG. 1) that work together to generate power. In particular, the rotor, which includes the blades and hub, is the most visible part and is responsible for capturing wind energy. As the blades spin, they drive the shaft connected to a gearbox that increases rotational speed before transmitting it to the generator, where electricity is produced. The nacelle houses the gearbox, generator, and other internal components, providing protection and support. The tower elevates the turbine to higher altitudes where wind speeds are stronger and more consistent. At the base, the foundation anchors the entire structure to the ground, ensuring stability. Additional components, like the yaw system (which rotates the nacelle to face changing wind directions) and control system (which manages performance and safety), ensure efficient and safe operation of the wind turbine.

The set of wind turbines 111, 112, 113 may be respectively configured with a set of wind sensors 116, 117, 118. Generally, each of the wind sensors 116, 117, 118 (i.e., an anemometer) may be installed on the nacelle of the corresponding wind turbine 111, 112, 113, where it can accurately measure wind conditions at the operating height of the wind turbine 111, 112, 113. This installation is often at or near the same height as the hub, which can range from 80 to 120 meters above the ground, depending on the design of the wind turbine 111, 112, 113. The wind sensor 116, 117, 118 may be securely mounted on a small mast or bracket to avoid interference from the structure and blades of the wind turbine 111, 112, 113, ensuring unobstructed airflow. The wind sensor 116, 117, 118 operates by capturing wind speed through rotating cups, propellers, or ultrasonic waves, depending on the sensor type. As wind flows past the wind sensor 116, 117, 118, it either spins the cups or propeller or disrupts ultrasonic waves, allowing the device to calculate wind speed based on the frequency or speed of rotation, or the time it takes for sound waves to travel between transducers. The captured wind speed readings are then sent to the respective control system of the wind turbine 111, 112, 113. In embodiments, the control system of the wind turbine 111, 112, 113 may use the information to optimize the yaw, blade pitch, and overall performance of the wind turbine 111, 112, 113 to maximize energy output and protect against damaging wind conditions.

FIG. 1 depicts three wind turbines 111, 112, 113 and three wind sensors 116, 117, 118, however it should be appreciated that alternative amounts of wind turbines and wind sensors are envisioned. Additionally, the wind turbines 111, 112, 113 may be part of the same wind farm or different wind farms. That is, generally, the wind turbines 111, 112, 113 may be located at the same or different geographic locations. According to embodiments, the control system of each wind turbine 111, 112, 113 may transmit or communicate the captured wind speed readings to a server computer 115 via one or more networks 110. In embodiments, the network(s) 110 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others).

The server computer 115 may be associated with an entity (e.g., a corporation, company, partnership, or the like) that may be configured to process observed data, in the form of wind speed data, along with WRF time series data, in association with the described systems and methods. The server computer 115 may be configured to interface with or support a memory or storage 114 capable of storing various data, such as in one or more databases or other forms of storage. According to embodiments, the storage 114 may store data or information associated with WRF time series data, observed wind speed data, machine learning models that are trained with WRF time series data and/or observed wind speed data, digital reports generated based on the analysis by the machine learning models, and/or other data.

The server computer 115 may communicate, via the network(s) 110, with one or more data sources 106 that may be associated with the generation or availing of WRF time series data. For example, the data source(s) 106 may be a research institution or university, government weather agencies such as the National Oceanic and Atmospheric Administration (NOAA), developer entities, meteorological or climate databases like those maintained by the National Center for Atmospheric Research (NCAR), commercial weather data providers, and/or other sources.

According to embodiments, the server computer 115 may retrieve or otherwise access WRF-related data from the data source(s) 106 (or from another source), and retrieve or otherwise access observed data from the wind turbines 111, 112, 113 (or from another source). The server computer 115 may perform various calculations, analyses, and processing of these datasets, including training a machine learning model using the processed datasets. The trained machine learning model may analyze a set of input WRF time series data and output a set of predicted TI values for a set of geographic locations indicated in the set of input WRF time series data.

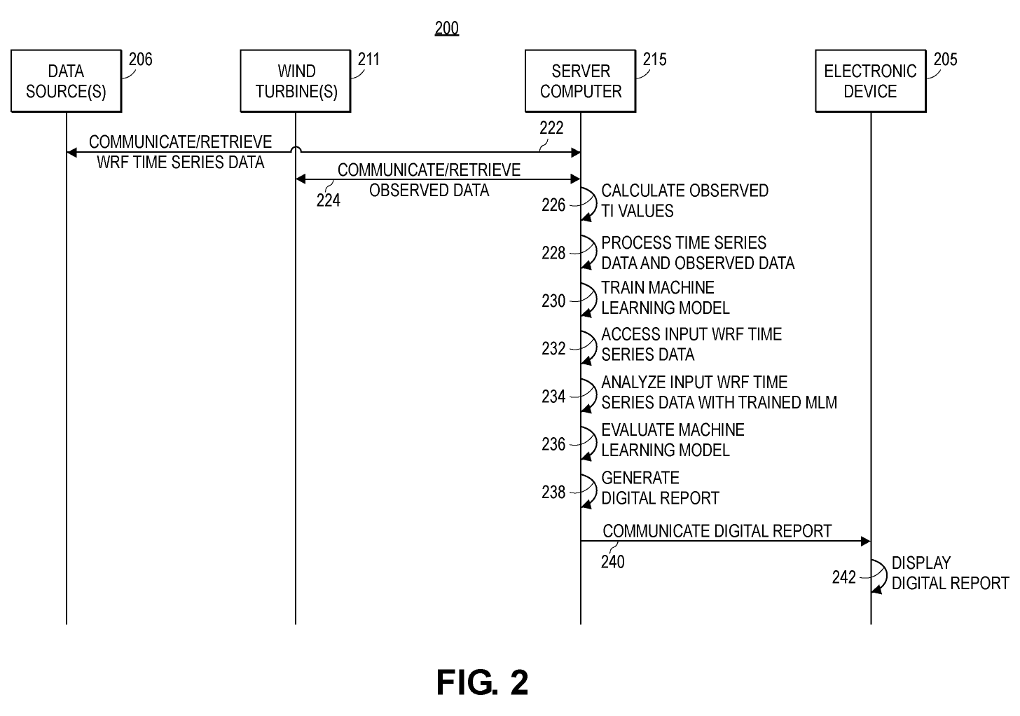

The server computer 115 may further generate a digital report based on the results of the machine learning model analysis. The server computer 115 may transmit this digital report to an electronic device(s) 105 for review and assessment by a user of the electronic device(s) 105. In embodiments, the set of input WRF time series data may originate from the electronic device(s) 105 (i.e., the user of the electronic device(s) 105 may be interested in TI values for a set of geographic locations). The electronic device(s) 105 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. The server computer 115 may store the digital report and other data associated with these techniques in the storage 114. Additional details regarding these functionalities is further discussed with respect to FIG. 2.

Although depicted as a single server computer 115 in FIG. 1, it should be appreciated that the server computer 115 may be in the form of a distributed cluster of computers, servers, machines, cloud-based services, or the like. In this implementation, the distributed server computer(s) 115 may be utilized as part of an on-demand cloud computing platform. Accordingly, when the electronic device(s) 105 interfaces with the server computer 115, the electronic device(s) 105 may actually interface with one or more of a number of distributed computers, servers, machines, or the like, to facilitate the described functionalities.

FIG. 2 depicts a signal diagram 200 including various functionalities associated with the described embodiments. The signal diagram 200 may include an electronic device 205 (such as the electronic device 105 as described with respect to FIG. 1), a server computer 215 (such as the server computer 115 as described with respect to FIG. 1), a data source(s) 206 (such as the data source(s) 106 as described with respect to FIG. 1, or another data source), and a wind turbine(s) 211 (such as one of the wind turbines 111, 112, 113 as described with respect to FIG. 1).

The signal diagram 200 may begin at 222 in which the server computer 215 may retrieve or access a set of WRF time series data from the data source(s) 206. It should be appreciated that the data source(s) 206 may provide the set of WRF time series data to the server computer 215 without the server computer 215 requesting the set of WRF time series data. Additionally or alternatively, the server computer 215 may request the set of WRF time series data from the data source(s) 206, or the server computer 215 may locally access the set of WRF time series data.

Generally, the WRF model is a numerical weather prediction (NWP) system designed to simulate atmospheric conditions at various spatial and temporal scales, and provides time series data which captures the evolution of different meteorological variables over a given time period at specific locations or grid points. WRF time series data may consist of multiple atmospheric variables that are recorded at regular intervals (temporal resolution) and at different locations (spatial resolution). These variables may include: wind speed (e.g., broken down into its U (east-west) and V (north-south) components) and direction, which may be provided at different altitudes or pressure levels; temperature, both at surface level and at various altitudes or pressure levels in the atmosphere; pressure, including surface pressure and pressure at different altitudes; humidity (e.g., specific humidity, relative humidity, and dew point temperature); precipitation (e.g., amount of rainfall or other precipitation types over time); turbulence metrics (e.g., variables related to atmospheric turbulence, such as Turbulent Kinetic Energy (TKE)); surface variables (e.g., soil moisture, surface temperature, and ground heat flux); and/or other variables.

The WRF time series data may also provide data at multiple vertical levels (i.e., sigma levels or pressure levels), and may be collected at regular intervals (e.g., every ten minutes, every hour, etc.). Further, the spatial resolution of the data may be determined by the grid size used in the simulation. WRF divides the geographical area of interest into a grid of cells, with each cell representing an area on the Earth's surface, and the spatial resolution typically ranges from one (1) km to tens of kilometers per grid cell.

The WRF time series data may be collected from larger-scale models (e.g., as the Global Forecast System (GFS) or the European Centre for Medium-Range Weather Forecasts (ECMWF)), and/or from real-world observations from various sources, including ground-based observations, radiosondes, satellite data, and radar and aircraft data. Once initialized with observational data, the WRF model may solve a set of complex mathematical equations (e.g., based on fluid dynamics, thermodynamics, and physics) to simulate atmospheric conditions. The model may divide the atmosphere into a 3D grid, where each grid point may represent a specific location and altitude. At each time step of the simulation, the model may calculate the changes in atmospheric variables like wind speed, temperature, and humidity at each grid point.

The WRF model may advance in time by taking smaller time steps, often on the order of seconds or minutes, though output is usually recorded at longer intervals (e.g., ten (10) minutes, hourly). During each time step, the model may output a "snapshot" of all relevant variables at each grid point, including wind speed, temperature, pressure, etc. These snapshots, when collected over time, form the time series data. Once the simulation is complete, the raw WRF output is typically processed using post-processing tools to generate time series data at specific locations or grid points.

For applications such as wind farm planning, time series data may be collected at specific geographical locations corresponding to proposed wind turbine sites. In such cases, WRF may be run at a high resolution over the area of interest, and the data from the grid points closest to the site may be extracted. When the exact geographical coordinates of the prospective wind farm are provided, the WRF may be used to simulate the weather patterns at that location. Because wind turbines operate at specific heights (e.g., 80-100 meters above ground), the model may output data at those exact altitudes or pressure levels. For accurate site assessments, WRF simulations may be run over extended periods (e.g., months to years) to capture seasonal variations and long-term patterns in atmospheric turbulence. According to embodiments, the WRF datasets as discussed herein may cover time periods ranging from ten (10) to twenty (20) years, or other time periods.

At 224, the server computer 215 may retrieve or access a set of observed data from the wind turbine(s) 211. It should be appreciated that the wind turbine(s) 211 may provide the set of observed data to the server computer 215 without the server computer 215 requesting the set of observed data. Further, in embodiments, the server computer 215 may access the set of observed data from another data source, for example the data source(s) 206, or locally. It should be appreciated that the set of observed data may be collected from sensors that are independent from the wind turbine(s) 211.

Generally, the set of observed data may include wind speed values associated with a set of locations. The wind speed values may be collected from wind sensors that may be placed/installed at different heights on the wind turbine(s) 211, or placed/installed on an alternative component, for example a communication tower, meteorological station, building, bridge, mast, and/or the like. The set of components on which the wind sensors are placed installed may be located at the set of locations such that each wind speed value has associated a location (e.g., latitude/longitude coordinates).

The server computer 215 may calculate (226) observed TI values at specific heights from the set of observed data. The wind speed data as included in the set of observed data may be measured at regular time intervals (e.g., every second, minute, or hour), using instruments such as wind sensors (i.e., anemometers) placed at a particular height above ground (e.g., at the hub height of a wind turbine, e.g., 80-100 meters). The server computer 215 may calculate the mean wind speed associated with a given wind sensor as the average wind speed over the time period of interest. For example, if measurements are taken every second over a 10-minute period, the

average wind speed is the mean of all of those measurements over the 10-minute period. The server computer 215 may additionally calculate the standard deviation of the wind speed, which captures the variability or fluctuation of the wind speed from the mean. A higher standard deviation indicates more variability in wind speed, which suggests higher turbulence.

Generally, TI is a measure of the variability in wind speed over a specific period, and it provides insights into how turbulent or stable the atmosphere is at a given location and time. Specifically, TI represents the ratio of the standard deviation of wind speed fluctuations to the average wind speed. In embodiments, a TI may be expressed as a percentage or decimal, and may be calculated as the standard deviation of wind speed (e.g., the horizontal wind speed fluctuations, often in the direction of the mean wind) divided by the mean wind speed over a specified period of time. According to embodiments, and prior to calculating the observed TI values, the server computer 215 may remove any wind speeds that are at or below a specified threshold speed (e.g., three m/s, or other speeds), and proceed with calculating the observed TI values using wind speeds that are above the specified threshold.

Generally, low turbulence includes TI values that are less than 10%, moderate turbulence includes TI values that are between 10-20%, and high turbulence includes TI values that are greater than 20%. Further, different factors may affect TI, including surface roughness (rougher surfaces (e.g., forests, urban areas) create more turbulence, while smoother surfaces (e.g., oceans, flat plains) generate lower turbulence), terrain (hilly or mountainous terrain tends to produce higher turbulence compared to flat land), atmospheric stability (stable atmospheric conditions (where temperature decreases slowly with altitude) often result in lower turbulence, while unstable conditions (where temperature decreases rapidly) cause more turbulent air), and obstacles (buildings, trees, and other large obstacles disrupt airflow and increase turbulence near the surface).

According to embodiments, the server computer 215 may associate/label the calculated TI values with relevant information. In particular, the calculated TI values may be labeled with (i) a height (i.e., top height) at which that observed data was collected, and (ii) a location at which the corresponding observed data was captured. For example, a data entry may associate a TI of 0.13 with corresponding latitude/longitude coordinates (i.e., the location of the wind sensor that captured the corresponding data) and a height of eighty (80) meters (i.e., the height of the wind turbine at which the corresponding data was collected).

The server computer 215 may perform (228) various data processing functionalities. In particular, after associating/labeling the calculated TI values with relevant information, the server computer 215 may aggregate the labeled data to construct a set of data comprising typical TI values over a given time period (e.g., a year or another time period). The server computer 215 may construct the set of data over the given time period by averaging the TI values over all of the given time periods for each combination of month, day, hour, and minute. In practice, most met masts may have a period of records spanning one (1) to six (6) years.

In embodiments, the server computer 215 may be configured to collocate the WRF time series data with the observed data by matching the spatial (i.e., geographical location) and temporal (i.e., time) components to ensure a direct comparison. In particular, the server computer 215 may identify common spatial points within the WRF outputs and the observed data, for example using a nearest neighbor approach where the nearest WRF grid point in terms of latitude and longitude is selected, or a bilinear interpolation to estimate WRF data values at the exact geographic coordinates of the observation site by weighting the four nearest grid points.

Further, the server computer 215 may match temporal resolution by aligning time intervals between the WRF time series and the observed data, as WRF outputs may be available at regular intervals (e.g., hourly), but observed data can have different intervals (e.g., every fifteen (15) minutes). Thus, the server computer 215 may employ interpolation if the observed data has finer resolution than the WRF time series data. For example, if the WRF time series data is hourly and the observed data is every ten (10) minutes, the server computer 215 may interpolate the hourly WRF data to the 10-minute intervals. If the observed data is coarser (e.g., daily averages), the server computer 215 may aggregate the WRF time series data to match the time step of the observed data, for example by averaging hourly WRF outputs to daily values.

In embodiments, the server computer 215 may interpolate the WRF time series data with a cubic spline technique to achieve the same ten-minute (or other period) granularity as the observed data. In embodiments, the cubic spline technique may enable values between existing data points to be estimated in a smooth, continuous way by fitting a series of piecewise cubic polynomial functions. Additionally, the server computer 215 may aggregate quantities over a time period (e.g., a year) to generate new features such as maximum, minimum, mean, and standard deviation of the respective original quantities. Further, the server computer 215 may merge observed data labels and WRF time series sets based on time of record (e.g., month, day, hour, minute, etc. of a typical year) and may concatenate all the sets vertically using a common set of features to create a unified set for training a machine learning model.

The server computer 215 may be configured to train (230) a machine learning model. In particular, the server computer 215 may train the machine learning model using the collocated set of time series data that is labeled with at least a portion of the observed TI values. In embodiments, the server computer 215 may construct an additional set of predictors or set of features that is additional to the WRF time series data. In particular, the server computer 215 may access or generate information regarding properties of the location, such as elevation, latitude, longitude, and/or other information. Additionally or alternatively, the additional set of predictors or set of features may include a variable related to terrain complexity, such as that based on the topographic position index (TPI). According to embodiments, the TPI is a spatial analysis tool that quantifies the relative elevation of a point on a landscape by comparing it to the average elevation of its surrounding area. Further, the TPI may incorporate the standard deviation of surrounding elevations as part of its analysis, which serves as a measure of the variability of elevations within the neighborhood around each target cell and provides context to interpret the TPI value more accurately. In embodiments, the server computer 215 may incorporate the additional set of predictors or set of features as part of training the machine learning model.

The server computer 215 may employ one or more training algorithms as part of training the machine learning model. For example, the server computer 215 may employ the CatBoost regressor, which is a machine learning algorithm that builds a predictive model by combining multiple decision trees, each of which improves on the errors of the previous trees in sequence. Using a technique called gradient boosting, CatBoost iteratively refines its predictions by adjusting to errors from previous steps, ultimately creating a highly accurate machine learning model. CatBoost automatically handles categorical data without requiring complex preprocessing, making it efficient for datasets with mixed data types. Additionally, it introduces an approach called "ordered boosting," which prevents the machine learning model from learning future information prematurely, reducing the chance of overfitting. It should be appreciated that alternative training algorithms are envisioned.

The server computer 215 may access (232) a set of input WRF time series data. In embodiments, the set of WRF input time series data may be associated with a set of input geographic locations at which it is desired to estimate a corresponding set of TI values. The server computer 215 may access the set of input WRF time series data locally or from a data source, such as the data source(s) 206, the electronic device 205, or another data source. For example, the electronic device 205 may send a request to the server computer 215 with the set of input WRF time series data, to have the server computer 215 analyze the set of input WRF time series data using the trained machine learning model.

The server computer 215 may analyze (234) the set of input WRF time series data using the trained machine learning model. In particular, the server computer 215 may input, into the trained machine learning model, the set of input WRF time series data, where the trained machine learning model may analyze the set of input WRF time series data and output a set of predicted TI values.

In embodiments, the predicted TI values as output by the machine learning model may capture the temporal evolution of TI, thus providing insights into how turbulent conditions vary over short to long time scales, such as hours, days, or months. The predicted TI values may be location-specific, each of which corresponding to individual grid points corresponding to specific geographical locations (e.g., proposed wind farm sites) as included in the set of input WRF time series data. The precited TI values may also specify multiple vertical levels corresponding to different heights above ground, which may align with wind turbine hub heights (e.g., 80-100 meters). Further, the predicted TI values may be of different granularity: higher-resolution data may offer finer temporal and spatial TI detail, while lower-resolution data may provide broader, more generalized trends in TI over time. Additionally, the predicted TI values may exhibit seasonal variation (e.g., higher turbulence in winter) and/or diurnal variation (e.g., peak turbulence during daytime due to solar heating and lower levels at night).

In embodiments, the server computer 215 may evaluate (236) the results of the trained machine learning model. In particular, the server computer 215 may identify a certain amount (e.g., five, or another amount) of locations and their predicted TI values for comparison to corresponding simulated WRF TI values, which may serve as baseline values. These identified locations/predicted TI values may be random (i.e., scattered throughout the globe) or as part of the same general location. According to embodiments, the server computer 215 may select the root mean squared error (RMSE) as the primary metric (i.e., the distance between the predictions and the observations, where the lower the value, the more accurate) and the coefficient of determination (R²) (the larger the value, the more accurate), the Pearson correlation coefficient (r²), and the mean bias as complimentary metrics to be used as part of the model assessment. The following metric values result from an assessment of the predictions of the machine learning model: RMSE = 0.040; R² = 0.33; r² = 0.37; bias = −0.003. The following metric values result from an assessment of the hourly simulations (i.e., the simulated (i.e., baseline) WRF TI values): RMSE = 0.057; R² = −0.4; r² = 0.34; bias = −0.005.

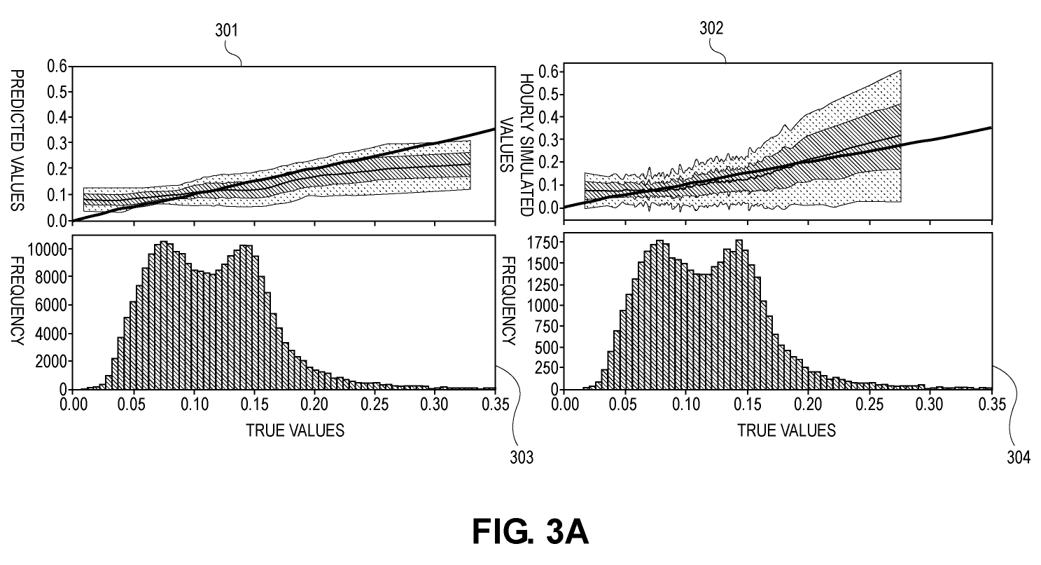

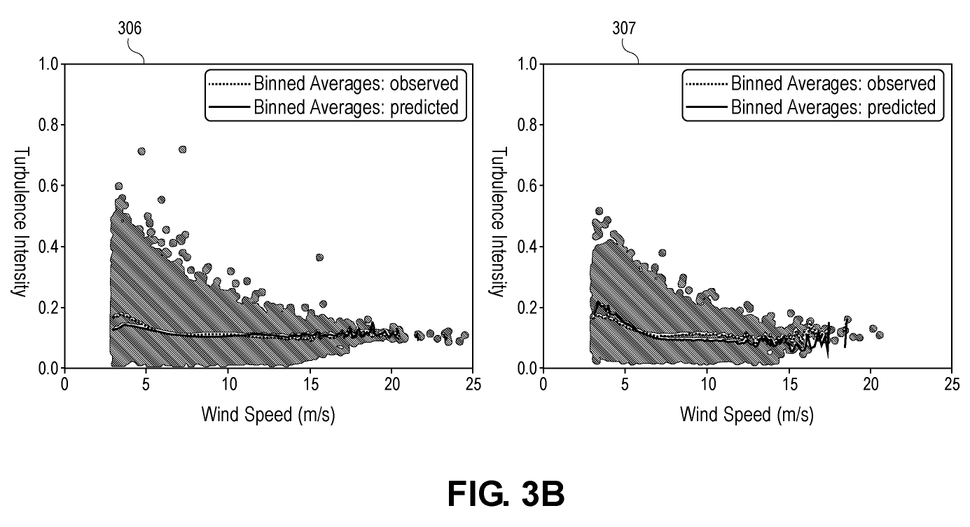

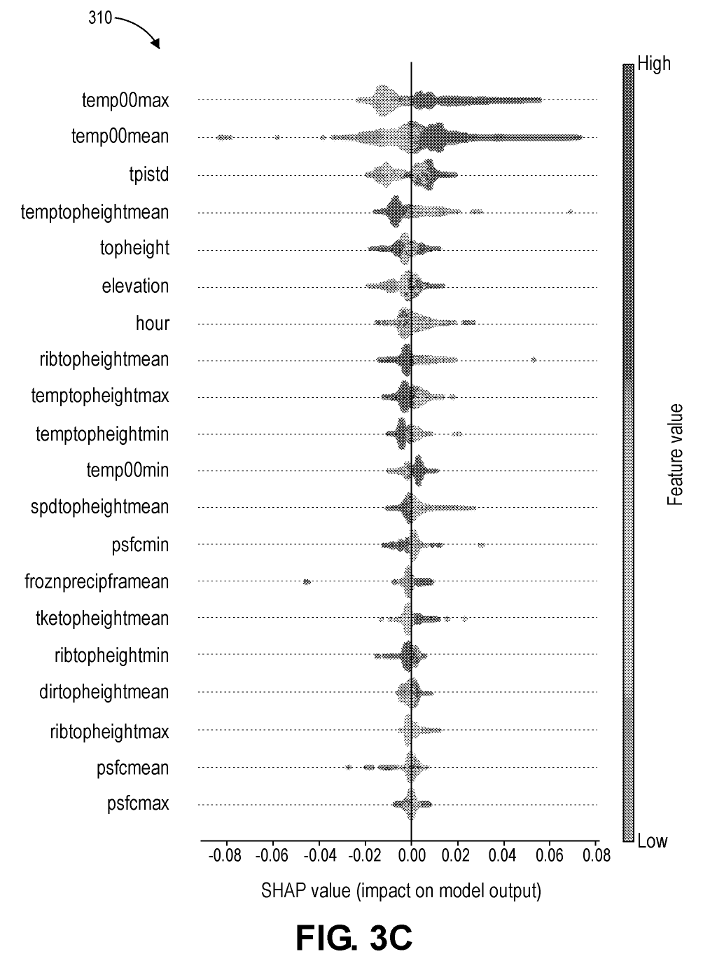

Accordingly, the predictions of the machine learning model achieve a reduction of about 30% in the RMSE when compared to the simulations, with a higher explained variance, as can be observed in graphs 301, 302, 303, 304 of FIG. 3A. In analyzing the behavior of the TI predictions with respect to wind speeds and comparing it to the WRF simulations, the curve of the machine learning model tends to be closer to observations, especially for wind speeds around and higher than fifteen (15) m/s, as shown in graphs 306, 307 of FIG. 3B. According to embodiments, the server computer 215 may employ the SHAP technique to rank feature importance. In particular, the standard deviation of the TPI appears to significantly influence predictions, alongside temperature-related variables. Additionally, elevation, hour, and top height also rank among the seven most relevant features, as shown in chart 310 of FIG. 3C.

The server computer 215 may generate (238) a digital report that may include information associated with the analysis by the machine learning model. In particular, the digital report may include the predicted TI values, as well as their corresponding geographic locations, vertical levels/heights, and/or any other data that may be output by the machine learning model or determined from the output of the machine learning model.

The server computer may communicate (240) the digital report to the electronic device 205. In embodiments, the electronic device 205 may be the same device that requests the server computer 215 to perform the analysis on the set of input WRF time series data. The electronic device 205 may receive the digital report and display (242) the digital report in a user interface for access and review by a user.

According to embodiments, the user may be an individual assessing a prospective wind farm site. Generally, by examining TI values, the individual can assess the variability of wind at the site, which helps predict potential structural loads and fatigue on wind turbines. This information is important for optimizing turbine design and ensuring that the selected models can withstand the turbulence levels at the site, thereby reducing the risk of mechanical failures and minimizing maintenance costs over time. Additionally, accurate TI data can inform turbine placement and spacing, enabling the individual to position turbines in a way that maximizes energy capture while reducing wake effects, which can increase turbulence and lower efficiency. Understanding TI also supports financial risk assessment; lower turbulence can lead to more stable energy production and reduced wear and tear, which can be favorable factors for investors evaluating the long-term viability of a site.

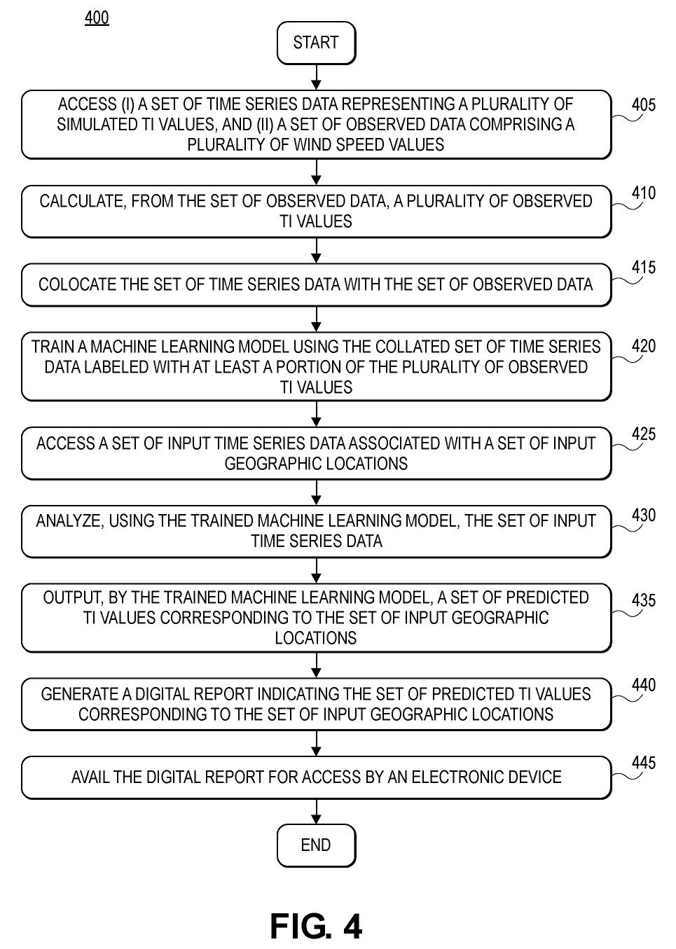

FIG. 4 is a block diagram of an example method 400 of predicting turbulence intensities associated with wind turbines. The method 400 may be facilitated by one or more computers (such as the server computer 115, 215 as described with respect to FIGS. 1 and 2).

The method 400 may begin when the computer accesses (block 405) (i) a set of time series data representing a plurality of simulated TI values, and (ii) a set of observed data comprising a plurality of wind speed values. In embodiments, the plurality of simulated TI values may be across a plurality of geographic locations, and the set of observed data may comprise the plurality of wind speed values collected over a set of time intervals, at a plurality of different sensor heights, and at a plurality of observed geographic locations.

The computer may calculate (block 410), from the set of observed data, a plurality of observed TI values. According to embodiments, the computer may identify, from the set of observed data, a portion of the plurality of wind speed values collected at a top height, of the plurality of different sensor heights, for each observed geographic location of the plurality of observed geographic locations, and calculate, for each of the portion of the plurality of wind speed values, an observed TI value. Further in embodiments, the computer may remove, from the set of observed data, a portion of the plurality of wind speed values that that are at or below a specified threshold speed, and calculate, for each of the plurality of wind speed values remaining after the portion is removed, an observed TI value.

The computer may collocate (block 415) the set of time series data with the set of observed data. In embodiments, the computer may align at least a portion of the plurality of geographic locations with at least a portion of the plurality of observed geographic locations, and interpolate the set of time series data to achieve a granularity that matches the set of time intervals of the set of observed data. Further, in embodiments, the computer may interpolate the set of time series data with a cubic spline technique to achieve the granularity that matches the set of time intervals of the set of observed data. The computer may train (block 420) a machine learning model using the collocated set of time series data labeled with at least a portion of the plurality of observed TI values.

The computer may access (block 425) a set of input time series data associated with a set of input geographic locations. Further, the computer may analyze (block 430), using the trained machine learning model, the set of input time series data. Additionally, the computer may, based on analyzing the set of input time series data, output (block 435), by the trained machine learning model, a set of predicted TI values corresponding to the set of input geographic locations.

The computer may generate (block 440) a digital report indicting the set of predicted TI values corresponding to the set of input geographic locations. Further, the computer may avail (block 445) the digital report for access by an electronic device. In embodiments, to access the set of input time series data for block 435, the computer may receive, from the electronic device, the set of input time series data associated with the set of input geographic locations.

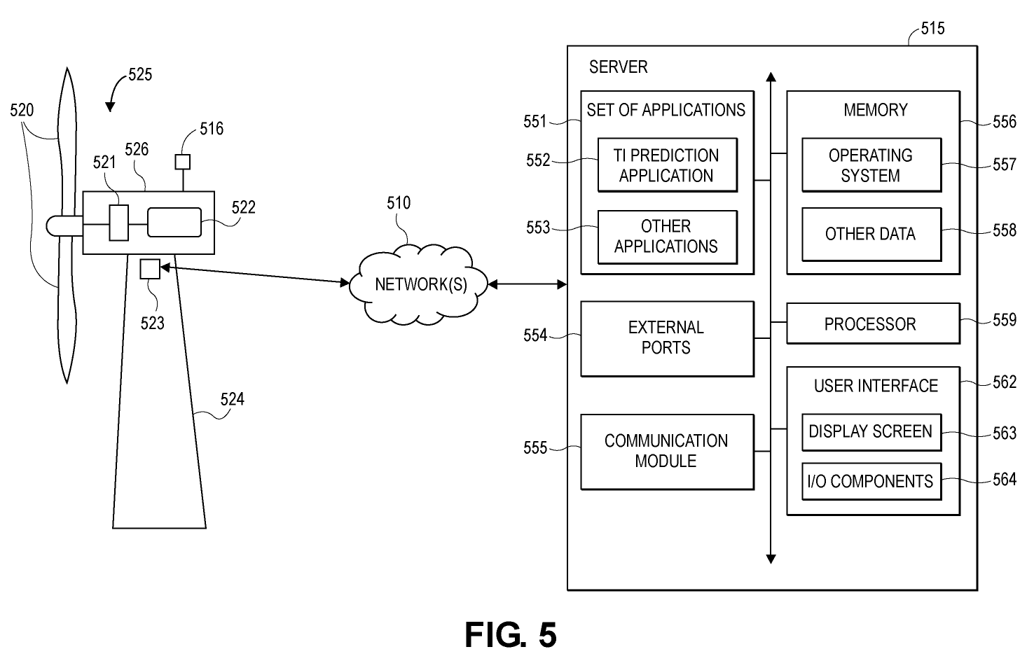

FIG. 5 illustrates a hardware diagram of an example wind turbine 525 (e.g., one of the wind turbines 111, 112, 113 as described with respect to FIG. 1) and an example server 515 (e.g., the server computer 115 as described with respect to FIG. 1), in which the functionalities as discussed herein may be implemented. It should be appreciated that the components of the wind turbine 525 and the server 515 are merely exemplary, and that additional or alternative components and arrangements thereof are envisioned. In embodiments, the server 515 may interface with a set of components other than a complete wind turbine. For example, the server 515 may interface with a set of met masts, each of which may be equipped with a set of sensors.

The wind turbine 525 may include a tower 524 which is a vertical structure that supports a nacelle 526 and rotor blades 520 at a height where wind speeds are stronger and more consistent. The tower 524 may be constructed of steel or concrete and may anchor the wind turbine 525 to the ground. The rotor blades 520 may be aerodynamic blades that capture wind energy and convert it into rotational energy. Typically there are three (3) rotor blades 520, which are designed to maximize efficiency while maintaining stability, although other amounts of rotor blades are envisioned.

The nacelle 526 houses a gearbox 521, which may connect a low-speed shaft (not shown in FIG. 5) from the rotor to a high-speed shaft of a generator (not shown in FIG. 5), and may increase the rotational speed to the level needed for electricity generation. The nacelle 526 may be located the top of the tower 526 and may contain components such as the gearbox 521, a generator 522, and control systems (not shown in FIG. 5), and may protect these components from the elements and support the rotor assembly. The generator 522 is a device inside the nacelle 526 that converts the mechanical energy from the rotating shaft into electrical energy, which is then sent to the grid or local storage. Other components associated with the wind turbine 525, such as power cables and a transformer, are envisioned but not depicted in FIG. 5.

The wind turbine 525 may further comprise a wind sensor 516 (i.e., an anemometer) that is configured to measure wind speed and, in some cases, wind direction. The wind sensor 516 may be mounted at an elevated location, such as on the nacelle 526, to capture accurate wind conditions. The wind sensor 516 operates by detecting the motion of the wind through rotating cups, a propeller, or ultrasonic waves, and converting this movement into wind speed readings.

A communication module 523 may be installed on or in the wind turbine 525 (e.g., on the tower 524 or nacelle 526, or within the nacelle 526), and may include an electronic system that enables real-time monitoring, control, and communication of the operational data of the wind turbine 525 with remote management systems (e.g., the server 515) for performance optimization and maintenance alerts. According to embodiments, the communication module 523 may transmit operational data associated with the wind turbine 525, including wind speed readings collected by the wind sensor 516, to the server 515 via a network(s) 510.

The server 515 may include a processor 559 as well as a memory 556. The memory 556 may store an operating system 557 capable of facilitating the functionalities as discussed herein as well as a set of applications 551 (i.e., machine readable instructions). For example, one of the set of applications 551 may be a TI prediction application 552, such as to train a machine learning model, access input WRF time series data, predict TI values based on using the machine learning model to analyze the input WRF time series data, generate digital reports, and/or other functionalities. It should be appreciated that one or more other applications 553 are envisioned.

The processor 559 may interface with the memory 556 to execute the operating system 557 and the set of applications 551. According to some embodiments, the memory 556 may also store other data 558, such as WRF time series data, observed data, and/or data that may be used in the analyses and determinations as discussed herein. The memory 556 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 515 may further include a communication module 555 configured to communicate data via the one or more networks 510. According to some embodiments, the communication module 555 may include one or more transceivers (e.g., WAN, WWAN, WLAN, and/or WPAN transceivers) functioning in accordance with IEEE standards, 3GPP standards, or other standards, and configured to receive and transmit data via one or more external ports 554. The server 515 may communicate, via the communication module 555, certain data (e.g., generated digital reports) to external electronic devices (not shown in FIG. 5).

The server 515 may further include a user interface 562 configured to present information to a user and/or receive inputs from the user. As shown in FIG. 5, the user interface 562 may include a display screen 563 and I/O components 564 (e.g., ports, capacitive or resistive touch sensitive input panels, keys, buttons, lights, LEDs, external or built in keyboard). According to some embodiments, the user may access the server 515 via the user interface 562 to review information, make selections, and/or perform other functions.

In some embodiments, the server 515 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 559 (e.g., working in connection with the operating system 557) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times.

Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of predicting wind turbulence intensities at prospective wind farm sites, the computer-implemented method comprising:
accessing, by at least one computer processor, (i) a set of time series data representing a plurality of simulated turbulence intensity (TI) values across a plurality of geographic locations, and (ii) a set of observed data comprising a plurality of wind speed values collected over a set of time intervals, at a plurality of different sensor heights, and at a plurality of observed geographic locations;
calculating, by the at least one computer processor from the set of observed data, a plurality of observed TI values;
collocating, by the at least one computer processor, the set of time series data with the set of observed data;
training, by the at least one computer processor, a machine learning model using the collocated set of time series data labeled with at least a portion of the plurality of observed TI values;
accessing, by the at least one computer processor, a set of input time series data associated with a set of input geographic locations;
analyzing, by the at least one computer processor using the trained machine learning model, the set of input time series data; and
based on analyzing the set of input time series data, outputting, by the trained machine learning model, a set of predicted TI values corresponding to the set of input geographic locations.

2. The computer-implemented method of claim 1, wherein collocating the set of time series data with the set of observed data comprises:
aligning, by the at least one computer processor, at least a portion of the plurality of geographic locations with at least a portion of the plurality of observed geographic locations; and
interpolating the set of time series data to achieve a granularity that matches the set of time intervals of the set of observed data.

3. The computer-implemented method of claim 2, wherein interpolating the set of time series data comprises:
interpolating the set of time series data with a cubic spline technique to achieve the granularity that matches the set of time intervals of the set of observed data.

4. The computer-implemented method of claim 1, wherein calculating the plurality of observed TI values comprises:
identifying, from the set of observed data, a portion of the plurality of wind speed values collected at a top height, of the plurality of different sensor heights, for each observed geographic location of the plurality of observed geographic locations; and
calculating, by the at least one computer processor for each of the portion of the plurality of wind speed values, an observed TI value.

5. The computer-implemented method of claim 1, wherein calculating the plurality of observed TI values comprises:
removing, from the set of observed data, a portion of the plurality of wind speed values that that are at or below a specified threshold speed; and
calculating, by the at least one computer processor for each of the plurality of wind speed values remaining after the portion is removed, an observed TI value.

6. The computer-implemented method of claim 1, further comprising:
generating, by the at least one computer processor, a digital report indicting the set of predicted TI values corresponding to the set of input geographic locations; and
availing the digital report for access by an electronic device.

7. The computer-implemented method of claim 6, wherein accessing the set of input time series data associated with the set of input geographic locations comprises:
receiving, by the at least one computer processor from the electronic device, the set of input time series data associated with the set of input geographic locations.

8. A system for predicting wind turbulence intensities at prospective wind farm sites, comprising:
a memory storing a set of computer-readable instructions and a machine learning model; and
at least one computer processor interfaced with the memory, and configured to execute the set of computer-readable instructions to cause the at least one computer processor to:
access (i) a set of time series data representing a plurality of simulated turbulence intensity (TI) values across a plurality of geographic locations, and (ii) a set of observed data comprising a plurality of wind speed values collected over a set of time intervals, at a plurality of different sensor heights, and at a plurality of observed geographic locations,
calculate, from the set of observed data, a plurality of observed TI values,
collocate the set of time series data with the set of observed data,
train a machine learning model using the collocated set of time series data labeled with at least a portion of the plurality of observed TI values,
access a set of input time series data associated with a set of input geographic locations,
analyze, using the trained machine learning model, the set of input time series data, and
based on analyzing the set of input time series data, output, by the trained machine learning model, a set of predicted TI values corresponding to the set of input geographic locations.

9. The system of claim 8, wherein to collocate the set of time series data with the set of observed data, the at least one computer processor is configured to:
align at least a portion of the plurality of geographic locations with at least a portion of the plurality of observed geographic locations, and
interpolate the set of time series data to achieve a granularity that matches the set of time intervals of the set of observed data.

10. The system of claim 9, wherein to interpolate the set of time series data, the at least one processor is configured to:
interpolate the set of time series data with a cubic spline technique to achieve the granularity that matches the set of time intervals of the set of observed data.

11. The system of claim 8, wherein to calculate the plurality of observed TI values, the at least one processor is configured to:
identify, from the set of observed data, a portion of the plurality of wind speed values collected at a top height, of the plurality of different sensor heights, for each observed geographic location of the plurality of observed geographic locations, and
calculate, for each of the portion of the plurality of wind speed values, an observed TI value.

12. The system of claim 8, wherein to calculate the plurality of observed TI values, the at least one processor is configured to:
remove, from the set of observed data, a portion of the plurality of wind speed values that that are at or below a specified threshold speed, and
calculate, for each of the plurality of wind speed values remaining after the portion is removed, an observed TI value.

13. The system of claim 8, wherein the at least one processor is configured to execute the set of computer-readable instructions to further cause the at least one computer processor to:
generate a digital report indicting the set of predicted TI values corresponding to the set of input geographic locations, and
avail the digital report for access by an electronic device.

14. The system of claim 13, further comprising:
a transceiver for communicating with the electronic device;
wherein to access the set of input time series data associated with the set of input geographic locations, the at least one computer processor is configured to:
receive, from the electronic device via the transceiver, the set of input time series data associated with the set of input geographic locations.

15. A non-transitory computer-readable storage medium configured to store instructions executable by one or more processors, the instructions comprising:
instructions for accessing (i) a set of time series data representing a plurality of simulated turbulence intensity (TI) values across a plurality of geographic locations, and (ii) a set of observed data comprising a plurality of wind speed values collected over a set of time intervals, at a plurality of different sensor heights, and at a plurality of observed geographic locations;
instructions for calculating, from the set of observed data, a plurality of observed TI values;
instructions for collocating the set of time series data with the set of observed data;
instructions for training a machine learning model using the collocated set of time series data labeled with at least a portion of the plurality of observed TI values;
instructions for accessing a set of input time series data associated with a set of input geographic locations;
instructions for analyzing, using the trained machine learning model, the set of input time series data; and
instructions for, based on analyzing the set of input time series data, outputting, by the trained machine learning model, a set of predicted TI values corresponding to the set of input geographic locations.

16. The non-transitory computer-readable storage medium of claim 15, wherein the instructions for collocating the set of time series data with the set of observed data comprise:
instructions for aligning at least a portion of the plurality of geographic locations with at least a portion of the plurality of observed geographic locations; and
instructions for interpolating the set of time series data to achieve a granularity that matches the set of time intervals of the set of observed data.

17. The non-transitory computer-readable storage medium of claim 16, wherein the instructions for interpolating the set of time series data comprise:
instructions for interpolating the set of time series data with a cubic spline technique to achieve the granularity that matches the set of time intervals of the set of observed data.

18. The non-transitory computer-readable storage medium of claim 15, wherein the instructions for calculating the plurality of observed TI values comprise:
instructions for identifying, from the set of observed data, a portion of the plurality of wind speed values collected at a top height, of the plurality of different sensor heights, for each observed geographic location of the plurality of observed geographic locations; and
instructions for calculating, for each of the portion of the plurality of wind speed values, an observed TI value.

19. The non-transitory computer-readable storage medium of claim 15, wherein the instructions for calculating the plurality of observed TI values comprise:
instructions for removing, from the set of observed data, a portion of the plurality of wind speed values that that are at or below a specified threshold speed; and
instructions for calculating, for each of the plurality of wind speed values remaining after the portion is removed, an observed TI value.

20. The non-transitory computer-readable storage medium of claim 15, wherein the instructions further comprise:
instructions for generating a digital report indicting the set of predicted TI values corresponding to the set of input geographic locations; and
instructions for availing the digital report for access by an electronic device.
